(19) United States
(12) Patent Application Publication
(10) Pub. No.: US 2013/0151352 A1
(43) Pub. Date: Jun. 13, 2013

(54) System Enabling Interactive In-Video Shopping from External Domains

(71) Applicants: Sin-Mei Tsai, Cupertino, CA (US); Diana Lynn Williams, Burlingame, CA (US); Gavin James Gordon Butler, San Carlos, CA (US)

(72) Inventors: Sin-Mei Tsai, Cupertino, CA (US); Diana Lynn Williams, Burlingame, CA (US); Gavin James Gordon Butler, San Carlos, CA (US)

(21) Appl. No.: 13/316,869

(22) Filed: Dec. 12, 2011

(51) Int. Cl. G06Q 30/02

(52) U.S. Cl. 705/14.73

(57) ABSTRACT

A system for shopping includes, an Internet-connected server, and software executing on the server from a non-transitory physical medium, the software providing a first function for embedding, upon request, a machine-readable code into the source code of a remote webpage, the machine-readable code specifying a link to video player software and a link to at least one digital video file, and a second function for establishing at least one bidirectional communication session between a remote appliance connected to the webpage and a host server.

### BACKGROUND OF THE INVENTION

1. Field of the Invention

The present invention is in the field of ecommerce, including sales and marketing systems and methods and pertains particularly to methods and apparatus for providing and maintaining interactive shopping opportunities to remote users connected to the Internet.

2. Discussion of the State of the Art

In the field of ecommerce, consumers may purchase products and services over the Internet through ecommerce websites adapted for the purpose. Ecommerce also involves efforts made by companies to reach more potential consumers through such methods as advertising over the Internet through various web-based mechanisms like web page advertising, and search-based advertising.

More recently, companies have sought out social networks as an advertising vehicle because of the viral nature of information spread through such social networks in light of the potential of reaching thousands to millions of people in a relative short period of time. A problem with current advertising is that the potential consumer, upon interacting with a web-based advertisement is often redirected from the webpage hosting the advertisement to the ecommerce site selling the products or services described in the ad.

It would be desirable for a web-based company selling products over the Internet to be able to reach a larger number of potential consumers in a relative short period of time and in a fashion that enables those consumers to shop without being redirected from the page they were on when they initiated contact.

Therefore, what is clearly needed is a system and methods for presenting an interactive shopping opportunity to one or more remote shoppers connected to the Internet.

### SUMMARY OF THE INVENTION

The problem stated above is that attracting more consumers is desirable for an Internet-based retail establishment, but many of the conventional means for attracting potential consumers, such as banner and search-returned advertising, also create inconveniences for potential consumers. The inventors therefore considered functional components of an ecommerce web portal looking for elements that exhibit interoperability and that could potentially be harnessed to provide an immediate shopping opportunity to potential consumers that are connected online but are remote from the shopping domain.

Every ecommerce shopping portal is propelled by repeated consumer patronage and loyalty. Therefore undertakings by the selling entity to attract more loyal consumers to the business are critical parts of day-to-day business operation. Most such ecommerce web-based businesses employ servers and software to communicate with potential consumers and to direct the potential consumers through the sales transaction process. These utilities along with proactive advertising campaigns designed to help reach more potential consumers are typically a part of such apparatus.

The present inventor realized in an inventive moment that if, at the point of introduction of the business to potential consumers, the potential consumers could immediately engage in a full shopping experience without requiring redirect the from the web page hosting the introduction mechanism, significant increase in consumer base for the business entity might result. The inventor therefore constructed a unique proactive shopping extension that allowed potential consumers to immediately engage in a full interactive shopping experience from a remote domain including, but not limited to a social interaction webpage. A significant increase in potential sales results, with less inconvenience to potential consumers created.

Accordingly, in an embodiment of the present invention, a system for shopping is provided and includes, an Internet-connected server, and software executing on the server from a non-transitory physical medium, the software providing a first function for serving, upon request, a machine-readable code embeddable into the source code of a remote webpage, the machine-readable code specifying a link to video player software and a link to at least one digital video file, and a second function for establishing at least one bidirectional communication session between a remote appliance connected to the webpage and a host server.

In one embodiment, the remote webpage is a personalized blogging webpage or a personalized social interaction webpage. In one embodiment, the request is initiated by a blogger through the personalized blogging webpage, or by a social interaction site member through the personalized social interaction webpage. In one embodiment, the host server is the Internet-connected server or a content server connected to the Internet-connected server.

In one embodiment, the at least one bidirectional communication session is brokered by a browser plug-in downloaded to the browser running on the remote appliance during load time of or during play time of the video. In one embodiment, the remote appliance is one of a desktop computer, a laptop computer, an android device, an iPad, or a smart phone.

In a preferred embodiment, the machine-readable code is redistributed after initial incorporation onto the remote webpage by a visitor to the remote webpage, the redistributed code specifying a different personalized webpage as a new or next destination for installation thereof. In a preferred embodiment, the one or more digital video files are interactive shopping videos.

In a preferred embodiment, the at least one bidirectional communication event is triggered by a shopper interacting with an interactive component integrated into the one or more digital video files. In this embodiment, the interactive component is visually displayed within the digital video or video player window during execution of or run time of the digital video. In a variation of this embodiment, the interactive component is one of an interactive video player control or an interactive video overlay. In another variation of the embodiment, the interactive video overlay is one of a logo, an icon, a button, a panel, or an input form.

According to one aspect of the present invention, a method is provided for presenting an interactive shopping opportunity to one or more remote shoppers connected to the Internet. The method includes the steps (a) sending a request to a website to serve an embeddable, machine-readable code into a remote webpage, the machine-readable code specifying a link to video player software and a link to at least one digital video file, (b) at the remote webpage, incorporating the machine-readable code into the source code of the remote webpage, and (c) executing the code to display the one or more digital video files for execution.

In one aspect of the method, the remote shoppers are connected to the Internet using one of a desktop computer, a laptop, an android device, an iPad, or a smart phone. In one aspect, in step (a), the remote webpage is a personalized blogging webpage or a personalized social interaction webpage. In this aspect, in step (a), the request is initiated by a blogger through the personalized blogging webpage, or by a social interaction site member through the personalized social interaction webpage.

In a preferred aspect, in step (a), the at least one digital video file is an interactive shopping video. In one aspect of the method, in step (c), the at least one digital video file is graphically represented in display by one or more video thumbnails. In another aspect, in step (c), the at least one digital video file is textually represented in display by one or more hypertexts. In one aspect of the method, in step (a), the request is sent as a result of a user clicking on an advertisement.

### BRIEF DESCRIPTION OF THE DRAWING FIGURES

FIG. 1 is an architectural overview of an ecommerce network enabling in-video shopping according to an embodiment of the present invention.

FIG. 2 is a sequence chart illustrating basic interactions performed to make in-video shopping available to potential consumers who visit social interaction sites.

FIG. 3 is a sequence chart illustrating basic interactions performed to make in-video shopping available to potential consumers who visit blogging sites.

FIG. 4 is a process flow chart illustrating steps for interacting with s potential shopper through a distributed video according to the embodiment of FIG. 1.

FIG. 5 is a plan view of an active video containing interactive components used to establish a shopping session according to the embodiment of FIG. 1.

FIG. 6 is a logical block diagram illustrating an active transaction session established as a result of in-video interaction according to an embodiment of the present invention.

### DETAILED DESCRIPTION

The inventors provide a unique system enabling interactive in-video shopping from external domains. The present invention is described in enabling detail using the following examples, which may describe more than one relevant embodiment falling within the scope of the present invention.

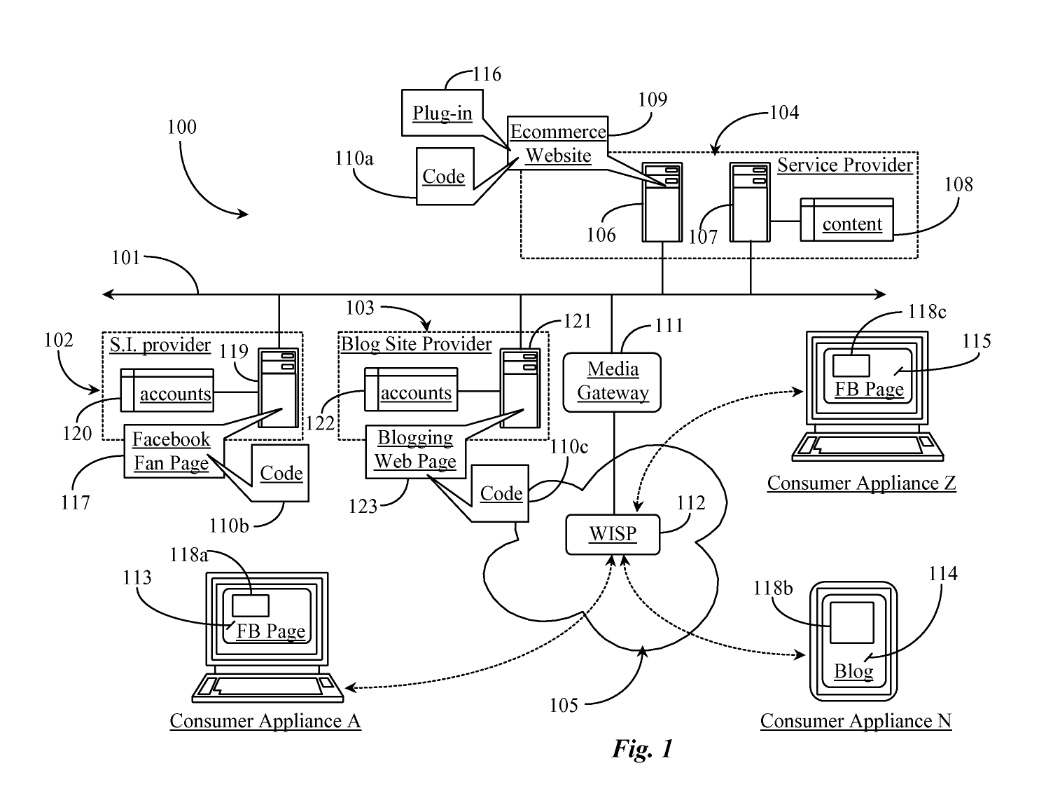

FIG. 1 is an architectural overview of an ecommerce network 100 enabling in-video shopping according to an embodiment of the present invention. Ecommerce network 100 includes the well-known Internet network referenced herein by an Internet backbone 101. Internet backbone 101 includes all of the lines, equipment, and access points that make up the internet network as a whole. Therefore, there are no geographic limitations to the practice of the present invention. Ecommerce network 100 also includes at least one sub-network 101 connected to Internet backbone 101. Sub-network 101 represents any communications carrier network utilized to connect potential consumers to the Internet. Sub-network 105 may be a wired or wireless network that may include such as the public switched telephone network (PSTN) and any cellular, or other wireless or wired carrier network.

A service provider 104 is illustrated in this example and represents any business that provides ecommerce (Internet-based shopping) for products and or services to connected consumers. In this regard, ecommerce service provider 104 maintains an ecommerce website 109 running on a web server 106 having connection to Internet backbone 101. Web server 106 includes a non-transitory physical medium adapted to contain all of the data and software required to enable web service. In this example, server 106 is owned by and maintained by service provider 104 and is considered to be within the domain of the service provider. In one embodiment, server 106 may be hosted by a third-party entity that provides ecommerce web-based services to business.

In a preferred embodiment, ecommerce website 109 is a shopping portal that enables users to shop online for any or the offered products or services made available through the web portal. In a preferred embodiment, videos (not illustrated) are produced and posted on site 109 that illustrate products and services that are available through the site. Also in a preferred embodiment, such videos demonstrating products and/or services are interactive meaning that potential consumers may interact with certain components embedded within or overlaid on the videos to establish connectivity required shop for available products and services from within those videos.

Service provider 104 includes a content server 107 that is connected to backbone 101 and that includes a non-transitory physical medium containing all of the data and software required to enable active content service relative to multimedia content including video and audio content. Content server 107 has connection to a content repository 108. Repository 108 contains all of the video and audio content for delivery to ecommerce website 109 or to any other domains that may have such video posted thereon. More detail about posting or distributing content videos on external domains is detailed further below.

Ecommerce website 109 is enhanced with a video embed code 110a that allows a specific video to be embedded on another website page. Embed code 110a contains a reference to a video file servable from content server 107 and a reference to a software video player used or preferred as a default video player for loading and playing video files. Code 110a is associated with a software plug-in 116 that is hosted by service provider 104 and that is invoked by the referenced software player whenever a specific video reference by the embed code is invoked. Plug-in 116 functions to manage communication between a consumer and the service provider whenever the consumer interacts with certain interactive components incorporated into an interactive shopping video being played. In a preferred embodiment, such interactive videos are distributed over the Internet virally by potential consumers that are interested in the products and serviced offered in any particular video.

In this example, a social interaction (S.I.) provider 102 is illustrated and represents any social interaction service provider that provides a website catering to social interaction between many users. A good example of such a service is Facebook™ Provider 102 includes a web server 119. Web server 119 includes a non-transitory physical medium that contains all of the data and software required to enable web service of web pages including a Facebook™ fan page 117 running on the server. Server 119 may be owned and maintained by the social interaction site provider or by a third-party web service provider without departing from the spirit and scope of the present invention.

Facebook™ fan page 117 is maintained by service provider 104 as the entities' social interaction fan page. Server 119 has connection to an account repository containing the account information for all users of the site. Service provider 104 may subscribe to more than one social interaction web service like Facebook™ and likely will have numerous fan pages established over a broad variety of social interaction websites in order to reach more potential consumers.

In this example, Facebook™ fan page 117 contains at least one shopping video posted thereto by an administrator or other authorized person performing marketing for service provider 104. In order to begin video distribution to potential consumers, the administrator may post one or more interactive shopping videos available on ecommerce website 109 to fan page 117. Embed code 110b reflects one video post and like code 110a, references a video player and at least one video file to serve or stream to the fan page when the video is played by an visitor to fan page 117.

In one embodiment, posting an interactive video available through ecommerce site 109 to fan page 117 includes distribution of plug-in 116 to the fan page. In this example, the plug-in may be loaded on server 119 and accessible whenever a user plays an embedded video on fan page 117. In another embodiment, embed code 110b may reference plug-in 116, which may served upon request whenever an interactive video is played on the fan page. In another embodiment, the plug-in is built into the video player referenced in embed code 110b.

A blog site provider 103 is illustrated in this example, and represents any service that provides blog space for users to post blogs online. Blog site 103 includes a web server 121 that includes a non-transitory physical medium containing all of the software and data required to enable web service functions including the service of web pages. Server 121 has connection to an accounts repository 122 that contains all of the blogger accounts established at the service by subscription. In this example, a blogging web page 123 is running on server 121 and represents a single blogging page maintained by a blogger. In this example, the blogger has posted at least one interactive video to page 123 utilizing embed code 110c. Embed code 110c is obtained from ecommerce website 109 or another posted location that references the same video or videos being distributed to blog site 123.

Each described service, social interaction and blogging has tools available for subscribers to add sponsored, or third-party hosted multi-media content to their individual pages. The embed object (in this case video) can be embedded in a social media site by various known mechanisms. A few examples are given below but are not meant to be a comprehensive list of methods by which an embed code can be added to a social media site. For example, at Facebook™, a fan page administrator may post a video embed object by selecting the “link” option in the post menu and then entering the universal resource locator (URL) of a page that contains open graph (OG) video references.

The open graph protocol enables any web page to become a rich object in a social graph. OG protocol supports embed of video of the type shock wave flash (SWF) extension, more recently renamed to small web format (SWF) so as not to be confused with actual Shockwave Flash Technology. All of these protocols and supported extensions for embedding video are known to and available to the inventors. When the URL referencing the video is entered into the address box, Facebook™ scrapes cover image, title, and description from the page. The embedded video then displays on the “wall” of the fan page (page 117).

In the case of a blogging site such as site 123, a blogger may obtain the embed code from ecommerce website 109 and post it on their blog page 123. The blogging site Tumblr™, for example, makes this simple by presenting the user with multiple options to embed. When a blogger selects the “video” option, the blogger can paste the embed code that corresponds to a video posted on ecommerce site 109. The blogger first navigates to the service provider's website (ecommerce site 109) and selects a video to post. Next, the blogger copies the embed code 110a associated with the video and pastes it into the text box on the blog post menu. The video then displays inline with the blog.

In both of the examples cited above, visitors to fan page 117 and visitors to blog 123 may interact with the embedded videos to shop for products and services offered through ecommerce site 109. Visitors may help distribute the videos to yet more potential consumers (site subscribers) in a viral fashion by selecting the social interactive functions “like” and “share” commonly associated with social interaction site postings. These actions result in automated postings of the same videos on the initiating visitor's own profile page wall in the case of Facebook™.

In this example, potential consumers are represented by consumer appliances A, N, and Z in this example. Consumer appliances A and Z are laptop computers in this example. Consumer appliance N is an iPad appliance. Potential consumers operating appliances A, N, and Z gain access to Internet backbone 101, in this example, through a carrier network 105, a wireless Internet service provider (WISP), and a media gateway 111 for transferring multimedia content efficiently and seamlessly between networks. Other Internet connection methods are available and may be considered in various embodiments of the present invention. Any computing device capable of browsing the Internet and playing video and engaging in a transaction over a network can be utilized as a consumer appliance in this example. This includes but is not limited to desktop personal computers (PCs), cellular telephones, android devices, personal digital assistants, set top boxes, and gaming stations.

In this example, consumer appliance A is running a browser application 113 displaying Facebook™ fan page 117 and may therefore play an embedded video represented herein as interactive video 118a. Consumer appliance N is running a browser application 114 displaying blog page 123 and may therefore play an embedded video 118b. Consumer appliance Z is running a browser application 115 displaying page 117 and may therefore play an embedded video 118c. In the case of Facebook™, the videos are on the “wall” of the Facebook™ fan page maintained by service provider 104. In the case of the blogging site, the video 118b is displayed in the blog.

In practice of the present invention, potential consumers such as those operating consumer appliances A, N, and Z may play videos 118a-c respectively, and may interact within those videos to engage in full service shopping without leaving the webpage they are currently on. In-video shopping in this example is enabled by plug-in 116, which establishes an interactive session between the consumer and the service provider through the video. Potential consumers may also select “like” or “share” functions associated with the respective posts to automatically repost those videos onto their own personal profile pages of the same social interaction service or on their own blog page of the same blog service. In this way, the service provider gains viral marketing potential for their products and services in a manner that imposes no inconveniences on the potential consumer like forcing a redirection of the consumer to the ecommerce shopping site.

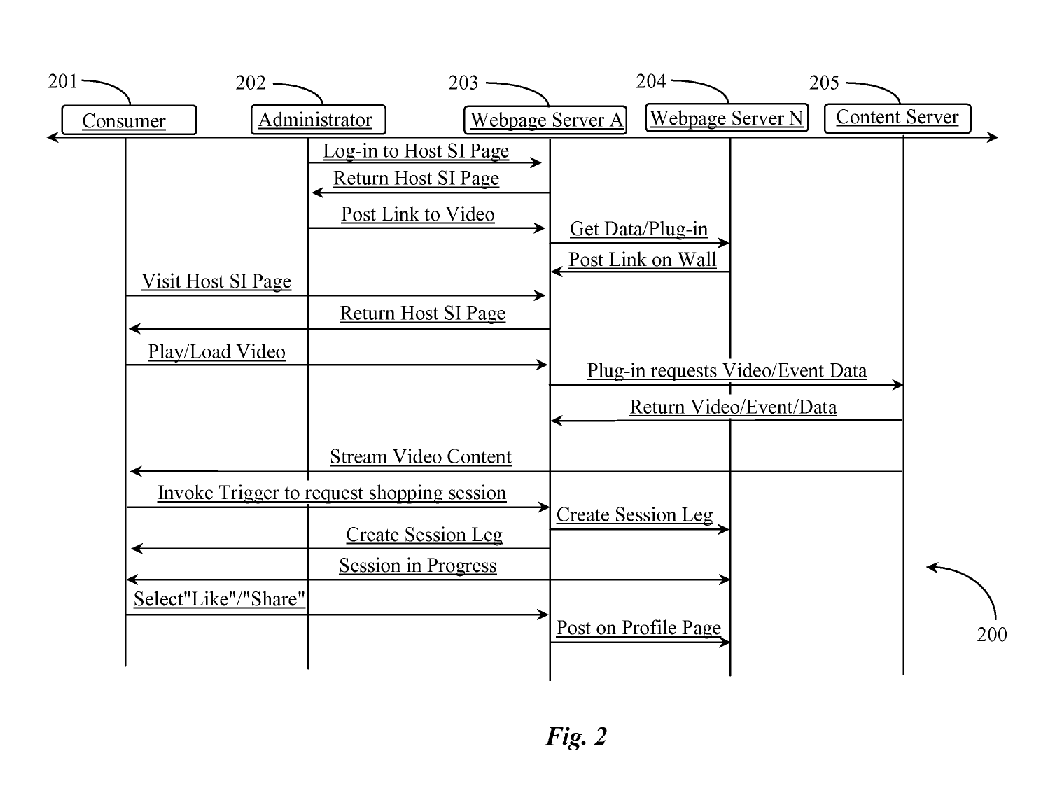

FIG. 2 is a sequence chart 200 illustrating basic interactions performed to make in-video shopping available to potential consumers who visit social interaction sites. Chart 200 is divided into five terminals of interaction. These are a consumer 201, an administrator 202, a webpage server A (203), a webpage server N (204), and a content server 205. It is noted that the sequence of interaction represented by chart 200 can be practiced using fewer or more than three servers without departing from the spirit and scope of the present invention. The inventor illustrates three separate servers for purposes of logical illustration only.

It is assumed in this example, that an interactive shopping video will be introduced to a social interaction site through a fan page subscribed to by the enterprise hosting the video. To begin the sequence, an administrator operating a network-capable computing appliance logs into a host social interaction page served to the administrator by webpage server A. The host social interaction page is analogous to a Facebook™ fan page. Next, the administrator posts an interactive video supporting open graph tagging to the fan page by utilizing posting tools and instructions available through the social interaction fan page post area.

The third-party host of the social interaction site navigates to the ecommerce site of the hosting enterprise and gets all of the relevant data and metadata about the video required to enable the posting and retrieves a software plug-in responsible for brokering interactive communication between the ecommerce site and the consumer. The ecommerce site returns all the data required for the post. The video, in the case of Facebook™ being the social interaction host, displays on the fan page wall. In this case, the video is now available to anyone visiting the fan page that has access to postings on the “wall” of that fan page.

Next, a consumer visits the host social interaction page, which is subsequently served by webpage server A (203). The consumer plays the video from the fan page wall. The video player referenced in the video embed code loads the plug-in immediately after play is invoked by the consumer. The plug-in establishes a connection between webpage server A and content server 205, which subsequently returns video and audio content of the video and event data relative to one or more trigger events, invocation of which during video runtime provides an interactive session between the consumer and the enterprise.

During video runtime, the plug-in registers relevant event callbacks as they relate to the specific video being played. The event callbacks are triggered by specific events listed in the event data returned with the video metadata required for the post. When a specific callback event is triggered, code is executed from the plug-in that enables a bi-directional interactive session enabling users to shop through the video.

Content server 205 streams the video content to the consumer. Next, the consumer establishes a listed trigger event resulting in a request from the consumer device to webpage server A (203). The software plug-in creates a connection between the consumer appliance and the ecommerce website residing on webpage server N (204). After brokering the connection, a bi-directional, interactive session is in progress wherein the consumer may provide input and get returned results including confirmation of purchase after a successful multi-step transaction process carried out by the consumer through initial interaction with interactive components in the video and subsequent interaction with components invoked at the point of the video run point (webpage server A) or with additional interactive components served by webpage server N to the consumer during the active session.

Trigger events may include events that happen automatically as a result of video player performance, and those that are invoked by the consumer using player controls. Among these are the events pre-play, play, pause, resume, stop, and end. The pre-play and end events are events that happen automatically when the video loads and when the video play ends. Play, pause, resume, and stop are events triggered by the user by invoking video player controls.

Interactive components that allow a user to shop from within a video are rendered as video overlays. A video overlay is rendered in a layer above the video data and may be provided in virtually any graphic form including but not limited to a logo, an icon, a button, a panel, or an input form. An overlay panel may contain text, graphics, or video that identifies the video or objects and persons within the video and or provides additional information about the video or objects and persons within the video. In the case of an input form, the form may be as sophisticated or a simple as any other electronic form. An input form rendered through an interactive video may include text fields, password fields, multi-line text areas, checkboxes, radio boxes, drop-down menus, and multiple option menu boxes.

In the case of video overlays, the overlay has certain display attributes including but not limited to appearance in the video for a planned duration of time; persistently anchored to a specific X,Y coordinate location in a video frame, and animation display for any purpose including to provide a seamless transition from one video frame to another frame or as a callout or call to perform some action such as proceed to checkout, or add item to an electronic shopping cart.

Referring back to FIG. 2, the consumer may engage in virtually any type of transaction with the ecommerce website that is supported by interactive components in the video being played. Transactions may include purchasing products and service, checking account credit balances, updating payment account information, securing automated assistance, etc. In one embodiment, videos automatically pause when an interactive session is taking place through the video.

After the bi-directional interactive session established between the consumer and the ecommerce site terminates, the video may end. The consumer has the option of hitting the like or share button associated with the video to automatically post the same video onto the wall of their personal profile page, in this example, from the fan page hosted on webpage server A to the consumer page hosted on webpage server N. In this way, the same video becomes available to yet more potential consumers. In this way, the videos are virally distributed throughout the personal profile pages of members of the social interaction site.

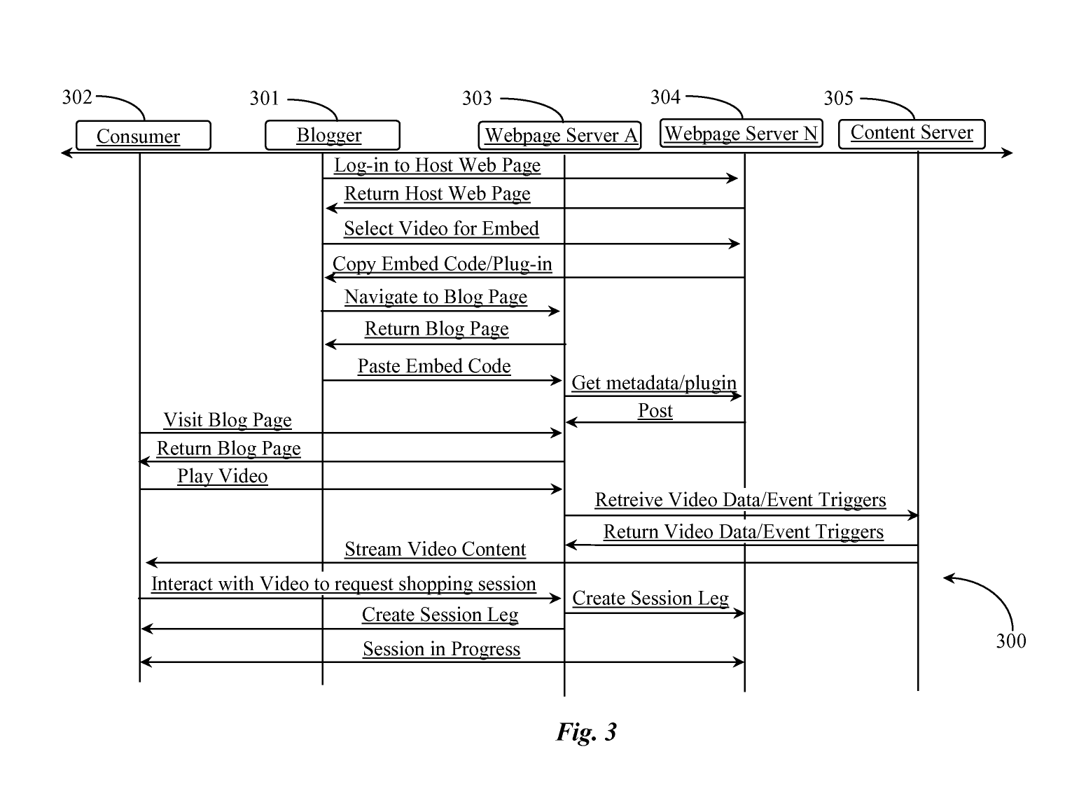

FIG. 3 is a sequence chart 300 illustrating basic interactions performed to make in-video shopping available to potential consumers who visit blogging sites. For purposes of illustration, chart 300 is divided into five terminals of interaction analogous to the terminals of FIG. 2 with the exception of a blogger replacing the administrator terminal of FIG. 2. The represented terminals are a consumer 301, a blogger 302, a webpage server A (303), a webpage server N (304), and a content server 305. It is noted that the sequence of interaction represented by chart 300 can be practiced using fewer or more than three servers without departing from the spirit and scope of the present invention. The inventor illustrates three separate servers for purposes of logical illustration only.

It is assumed in this example, that an interactive shopping video will be introduced to a blogging site like the site Tumblr™, for example, manually by a blogger. To begin the sequence, blogger 301 operating a network-capable computing appliance logs into the ecommerce site served to the blogger by webpage server N (304). Next, the blogger selects a video to post on his or her personal blog page. At the ecommerce site, the blogger copies the video embed code, which includes the software plug-in hosted by the ecommerce site.

Next, the blogger navigates to his or her personal blog page hosted on webpage server A (303). Webpage server A returns the blog page to the blogger after authentication. The blogger then pastes the embed code into his or her blog. This results in a video posted inline on the personal blog page of blogger 301 that is available to any visitor accessing the blog page containing the blog and video post.

Consumer 302 visits the blog page containing the video post. Webpage server A returns the blog page to the consumer. The consumer then plays the video. The embed code references a video player and the video to be played. The video player has access to the software plug-in, which was returned with the embed code and which could be an executable piece of the code. The video player, when called to play the video immediately loads the software plug-in.

The software plug-in establishes a connection from Webpage server A to content server 305 to retrieve the video data and event triggers. The event triggers are registered within the software plug-in for that particular video. Event triggers may be different for different videos. The content server delivers the video and audio content and interactive components included in the video data. Consumer 302 interacts with at least one interactive video component to request an interactive shopping session, or some other type of interactive session.

Upon interaction with a component registered as a trigger event within the software plug-in causes a bidirectional session to be established between consumer appliance 302 and the ecommerce site hosted on webpage server N, the connection established by the plug-in from the point of webpage server A. The transaction session is then established in a secure manner for the ensuing transaction. In one embodiment, the consumer may elect to post the video on their own blog site if they have one, or on some other accessible webpage maintained by or subscribed to the consumer so that it may be available to yet more potential consumers.

In one embodiment, the option to post a video from the ecommerce site is propagated within an interactive advertisement that may be a banner ad posted on one or more a high traffic websites by ecommerce administration. In one embodiment the advertisement is a search advertisement searchable by keyword or phrase. In this embodiment, any user could be directed to post the video on their social interaction site or other personal or accessible public webpage. There are many possibilities.

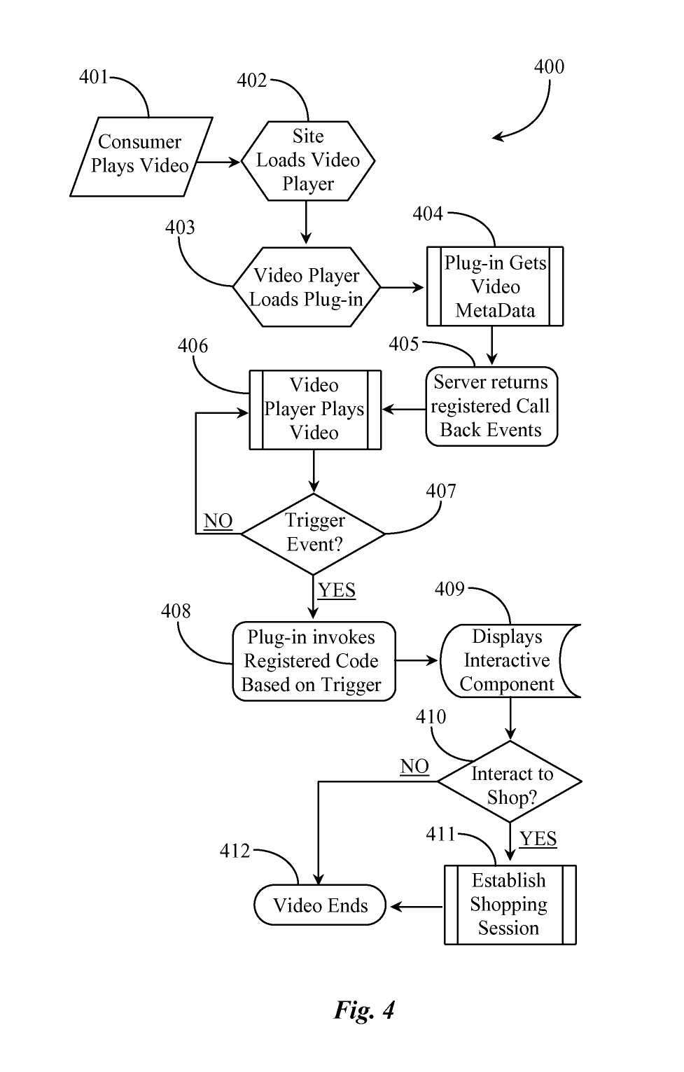

FIG. 4 is a process flow chart 400 illustrating steps for interacting with a potential shopper through a distributed video according to the embodiment of FIG. 1. At step 401, a consumer plays a video from a social interaction site, blog site, or other webpage containing the appropriate video post. At step 402, the local website (server) loads the video player, which in turn loads the software plug-in at step 403. At step 404, the plug-in calls the content server and to get all of the video metadata including all of the current trigger events, video content, and interactive components that will accompany the video.

In a preferred embodiment, the video metadata providing the video thumbnail and video description at minimum is part of the post so that the consumer may see the video description at least before hitting the video play button. However, this is not a requirement for practicing the present invention. The consumer may, in one embodiment, see only a URL text link to the video, which upon invocation, return the video player, thumbnail picture representing the addressed video, and any available description of the video.

At step 405, the content server, or in some cases the server hosting the ecommerce site returns all of the registered call back events to the software plug-in, if this step has not already been performed during the video posting process. In one embodiment, trigger events may be changed or modified requiring an update too the posting. For example, limitations in product availability may cause one or more of the interactive components and one or more trigger events to be disabled in the video playback. This may occur by omission when video content is streamed to the player. One example might be not displaying a specific overlay related to a product in the video that is no longer available for purchase or is out of stock. A replacement overlay may be introduced, for example, that calls attention to a similar available item that was not featured in the video content but that is featured and described by the interactive overlay. The interactive overlay may be video on video.

As the video plays, the software plug-in looks for any event triggers at step 407 that register the request of a consumer playing the video to launch an interactive session. If no event triggers have been invoked, the process may resolve back to step 406 while the video continues to run. If the plug-in registers an event for call back at step 407, the plug-in invokes the code relative to that event to launch one or more interactive components, interaction therewith leading to a bidirectional session. In one embodiment, the trigger is automatic and the interactive component becomes visible at the trigger event. In another embodiment, the interactive component or components automatically display at their preprogrammed cue points, persistently throughout the video, or during specific time windows during the video playback. In one embodiment, the trigger event is invoked by the consumer such as pausing the video and mousing over an item being described in the video.

At step 409, the video player displays one or more interactive components called by trigger events or that are deemed trigger events. The flexibility here is inherent in the design of the list containing the call back event conditions. For example, a consumer could play the video and then immediately see a persistent banner that says shop now. The banner may display throughout the video but may not be considered a trigger event until the consumer clicks on the banner to launch a session. In another example, the consumer might play the video and may not see any displayed interactive components in the video unless an item in the video is clicked on or moused over causing a buy now component to display.

At step 410, the consumer makes a decision whether to interact with a presented option in the video. If the consumer elects not to interact with the video, the process may end with the video at step 412. However, if the consumer interacts with an interactive component presented to them through the video, the plug-in may establish an interactive session (call back) at step 411. Such an interactive session may include only the consumer appliance and an automated system hosted at the ecommerce website. Such a system may be developed and maintained using traditional tools and protocols available for enabling automated web-based services. Options for engaging in live transactions with agents of the enterprise hosting the video may also be presented through the video as interactive components. One such component may be a banner that pops up when the consumer clicks on an interactive component in the video that says click here to see current availability data about the selected product.

After completing a transaction through the video, the consumer may terminate the session and the video then ends at step 412. In one embodiment, the transaction session may involve multiple steps and may have a time frame that surpasses the play window of the video. In one embodiment, the video may be paused during the transaction process and resumed afterwards, especially if there are more opportunities to shop remaining in the video after the transaction has completed. In a preferred embodiment, information about the consumer may be solicited during an interactive session for the purpose of completing transactions or servicing the consumer. Information may be gathered during the process of video interaction such as identifying the consumer by name, gathering contact information, noting place marks or “bookmarks” in the video that can be resumed if the consumer returns to the same video. Moreover, the enterprise hosting the system may offer more of the same categories of shopping videos if it determines that the consumer has a preference for certain product styles and coordination schemes such as in the case of fashion products and services.

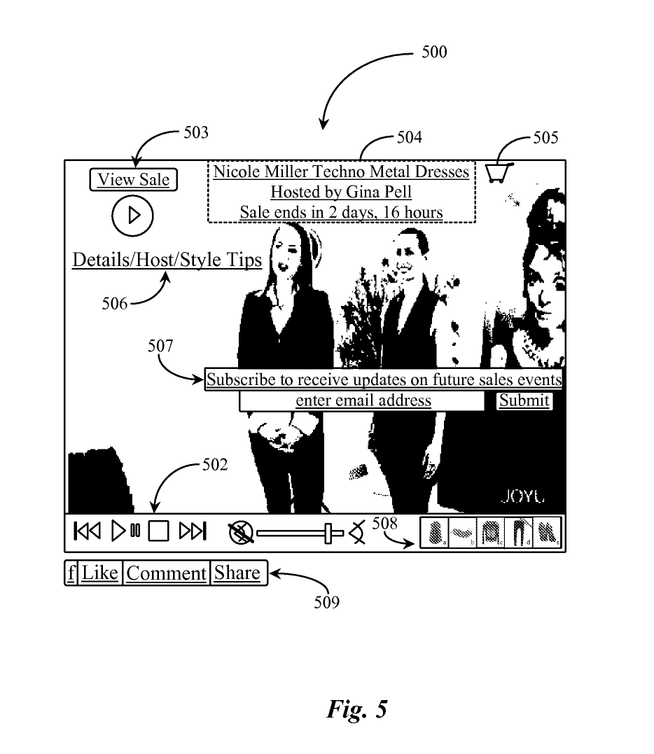

FIG. 5 is a plan view of an active video 500 containing interactive components used to establish a shopping session according to the embodiment of FIG. 1. Video 500 includes a control panel 502 including all of the controls generally associated with video playback such as skip backward or forward, play, pause, stop, and volume controls. Control bar 502 may contain more or fewer controls than are illustrated in this example without departing from the spirit and scope of the present invention.

In one embodiment, player controls may be assigned as a trigger event that triggers display of an interactive component in the video. For example, pausing the video may cause one or more interactive components within the video to display while the video remains paused. When the consumer resumes video playback the components are not again displayed until the consumer pauses the video again. In other embodiments, various display orders could be observed and registered for interactive video components like video overlays, for example. An overlay may be persistently visible for the entire video playback or for a specified time of video playback.

In one embodiment overlays are triggered by a user action like clicking on or mousing over a desired product being featured or displayed in the video. In one embodiment, automatic states may trigger interactive options such as when the video ends or during transition from one product display and description to a next product display and description within the same video. The interactive options may vary widely in type, display parameters, and animation capabilities.

Video 500 includes several interactive components displayed in this view including a view sale button 503, that may start the video or may call back current pricing or discount information for the sale. Video 500 includes a banner notification 504 that provides information about the video and persons in the video and information about when the current sale advertised by the video ends. Such a notification may be preprogrammed to display or not to display depending on conditions at the host environment. For example, if the sale lasts two weeks, the banner 504 may not display at all unless there is less that one week to go.

Video 500 includes an interactive component 506 that provides product details, host information, and style tips if interacted with. Another interactive component 507 is included within video 500 and enables a consumer to subscribe to information from the ecommerce site about future sales events that may include information about how to access interactive shopping videos relative to those future sales. Video 505 contains an interactive shopping cart icon 505 that allows the consumer to drop products from the video into the shopping cart.

Video 500 includes an interactive display 508 that displays the products discussed in the video in small thumbnails on control bar 502. A consumer may select any one of the displayed product thumbnails to jump to the portion of the video that describes that product. In one embodiment, selecting one of thumbnails 508 prompts the consumer to “buy now” initiating the interactive shopping session. In this example, social proliferation tools 509 are provided adjacent the video enabling the consumer to share the video on their own personal profile page in addition to the ability to provide comments about the video and the contents of the video.

It will be apparent to the skilled artisan that other interactive options may be presented through video 500 than are illustrated in this example. Video overlays may render in various ways, including, but not limited to automated rendering at preprogrammed cue points; rendering upon user interaction with an object in the video by mouse click or hover over; or via consumer interaction with a “hint” element showing the consumer that an object is interactive and that the element is selectable to initiate an interactive video overlay that further provides interactive options to the consumer upon further interaction with the overlay element. Notwithstanding various ways to provide display of interactive components, the preferred application seeks to provide a rich and minimally obstructed video experience for the consumer while preserving the capability of interactive shopping through the video.

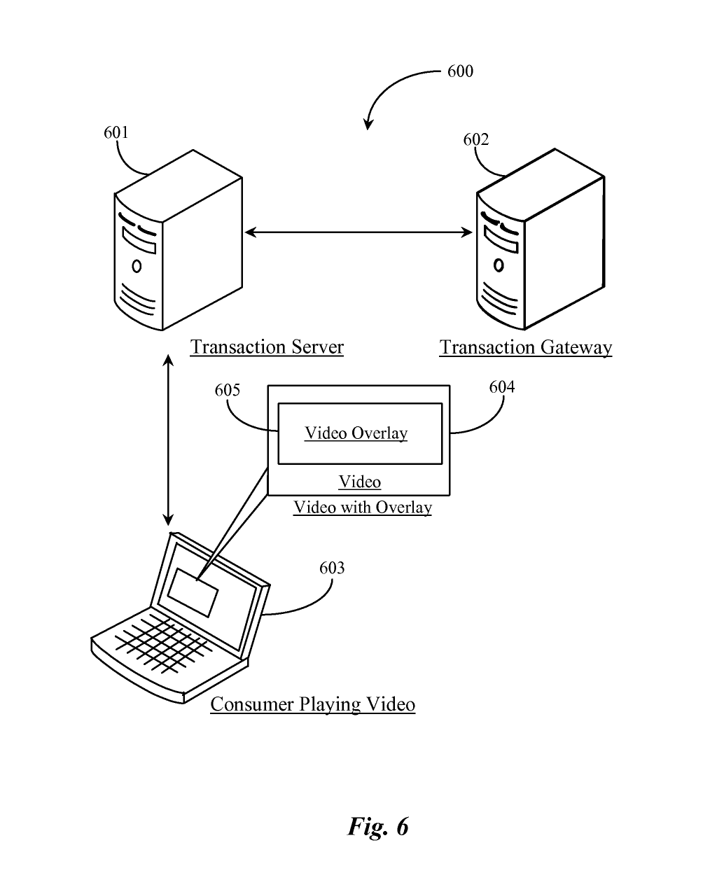

FIG. 6 is a logical block diagram 600 illustrating an active transaction session established as a result of in-video interaction according to an embodiment of the present invention. Diagram 600 includes a consumer appliance 603 having connection to a transaction server 601 as a result of interaction with a video overly 605 of a video 604 playing on the appliance. In the case of a transaction requiring the exchange of security information, a secure transaction gateway server 602 is utilized for secure transaction purposes.

The consumer, through video overlay components, interacts with the video and may perform certain actions including, but not limited to submitting input; controlling video playback such as jumping to a specific point in the video; jumping to a different video linked to the original video through an option such as “more like this”; and changing any user-settings like, for example, hiding or showing the video overlays, changing display attributes like font size or zoom characteristics; or displaying closed captioning.

The interaction with specific elements causes server return of data in real time, the data in many cases further enabling the shopping experience for the consumer. The data returned based on interaction may include the name of the sale and or the URL location of an independent web site where the sale and other sales may be hosted. The data returned may include the availability of the sale expressed in start and end time. The data returned as a result of interaction may further include the names and titles of the hosts presenting the sale items in the video. This information may be correlated to the times and locations of these hosts within the actual video playback.

Other data that may be returned includes data about the products that appear in the video sale. These products may be presented separately or together and may be associated with the times and locations of the products in the video. Other relevant product data available through the video may include the brand of the product, the name of the product, the current price for the product, including but not limited to retail price, and discounted price, where applicable. Data returned may include the rewards points for purchase of the product, if applicable.

In one embodiment, data returned as a result of interacting with an interactive component in the video may also include the URL location where more detail about the product, including shipping and return policies, authenticity guarantees, and the like can be found. Returned data may include additional product attributes like more detailed description of the product including but not limited to available sizes, available colors, fitting data, one or more still images of the product, one or more 360 degree videos of the product by itself, product materials, care instructions, and order information like shipping estimates, shipping methods, return timeframe and purchase limitations if any.

Interaction with one or more interactive components within the video may return data about style tips related to the products in the sale. Such style tips may be rendered as overlays and may be associated with specific cue points in the video, where the style tips can be more logically introduced. Returned data may also include an interactive form for subscribing to sale announcements, including but not limited to a prompt to entice users to subscribe, labels for each returned form field, web service location of the service performing subscription establishment for the consumer.

Additional data that may be returned during the shopping experience may include code to validate the form fields, consumer messaging in case of success or error made on the input form, or another form for selecting a specific version of the product, for example, size and color. In one embodiment, a consumer may add personalization to a product intended for purchase including selection of letters for initialing a purchased necklace for example. Moreover, during the transaction process, data returned may include a list of identifiers for the credit cards that are already saved for the consumer at the ecommerce website, if applicable (repeat customer). The data returned during a transaction may additionally include a list of shipping addresses that are already saved for the consumer at the ecommerce website, if applicable. Still more data types returned may include previous shopping cart contents, if any; forms to allow user to add or change credit card and shipping addresses and web service location where the user input should be securely posted; and social functions equivalent to like, tweet, share, and embed.

The product data that is invoked in real-time during video play may reflect the availability of the sale, based on whether product inventory exists or remains. If the product inventory is low at the time of interaction, the consumer may be notified with a message, such as “Only 2 items left!”. If the product inventory is out, the system may be triggered from the ecommerce end not to display the video overlays for out-of-stock products, especially if there are space constraints limiting which products may be featured or called out in the video.

Regarding transaction initiated through the video, they may include subscribing to future sale announcements, adding items to shopping carts, and purchasing items in a shopping cart by completing the steps in a check-out flow. The transactions are made possible through the form video overlay elements. Consumer input is submitted to the web services operated by the ecommerce website where the transactions commit.

As described further above, context about the potential consumer may be passed into the video player. This enables personalization of the shopping experience. The ecommerce web services can determine if the consumer has previously subscribed to sale announcements. If already subscribed, then the consumer is not presented with a subscribe button or form overlay in the video. If the consumer has previously saved wallet information on file with the ecommerce website, then the consumer may be prompted to choose a payment account to pay from during a transaction.

If the identified consumer has saved shipping addresses, the ecommerce server may auto fill shipping addresses during checkout. If the consumer previously saved items to a shopping cart utility, the ecommerce server may present their saved shopping cart contents during checkout. The server may monitor and remember consumer interaction with the video so that a higher quality consumer experience can be provided. For example, if a consumer subscribes to sale announcements via video overlays, this preference is remembered in a cookie. The overlays may be omitted in future videos accessed by that consumer once the consumer is identified as the consumer playing the video. In another example, a consumer who watches a video then terminates the video before the video ends may resume the video where they left off when they return and reactivate the video. This depends on identification of the consumer once play begins.

Any consumer purchases or shopping cart placements may be remembered in terms of preferred style, sizes and colors so that future offers to that consumer contain like items. If a consumer changes any video player or video overlay settings (e.g. display closed caption, hide/show video overlays, show product details), the settings may be remembered for future video playback sessions engaged in by that same consumer. A cookie system might be used to identify the consumer at the time of video invocation.

The in-video shopping experience of the present invention may be presented in a format similar to television today where after one show plays, another show is presented automatically with proper transition elements incorporated between the shows as needed. This allows the consumer to remain on the website they are currently on while fully enjoying the benefits of shopping with the hosting enterprise. In one embodiment, the auto-play format of in-video shopping may make use of past behavior from the user to select which video to auto-play next. For example, videos that the consumer has watched in full may not be automatically presented again until after a preset time frame has expired, the time frame beginning after the last viewing.

In a multi-video interface, videos that present merchandise similar to merchandise that the user previously preferred as interpreted through browsing behavior, shopping cart placement, search activity, and or purchase information may be presented first in a list of viewable videos. Also in this embodiment, videos where the product inventory matches the known criteria of the consumer including gender and size requirements may be presented first. In another example, videos hosted by persons that the consumer has expressed an interest explicitly or implicitly, including through a “follow host” subscription function or through other site behavior, may be presented first.

In one embodiment, consumers may be enabled to modify the auto play video function in a video player interface posted on a social interaction page. For example, that has a list of videos to present algorithmically. This might be accomplished through a personalization function using a search function to enter one or more search terms or by selecting categories in a prioritized fashion to inform the sorting function of the auto-play algorithm which videos to give priority in order of play to that consumer. If the next consumer that interacts with the video player interface does not have preferences pre-set or does not set preferences before hitting play video, the default order of videos will be listed and presented. The feature immediately described above may be monitored by the enterprise through cookie exchange where the preset data may reside along with identification of the consumer.

At video preload stage, the plug-in can establish a connection with the ecommerce server to exchange cookies. A copy may be retained at the plug-in for use in calling up the proper video sort for the auto-play algorithm to run once play is activated at the video interface. In another embodiment, the consumer may see the video list and may be enabled to manually create a play list or “favorites” list. Such lists may be shared on the consumer's personal profile page in association with the video interface (embedded video link) so that other users may hit like or suggest other preferred video or play orders or priorities.

An example might be a user Jennifer likes Jane's video play order of video sales from a fashion website. Jane may then apply the same order to a version of the player interface (embedded video link) on her own profile page. In this way, groups may have influence on which hosts, products, and services get priority by being presented to consumers first. The fact that it is consumer driven increases the likely hood of more transactions and better loyalty among the consumers base for that enterprise.

It will be apparent to one with skill in the art that the in-video shopping system of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. A system for shopping, comprising:
an Internet-connected server; and
software executing on the server from a non-transitory physical medium, the software providing:
a first function serving, upon request, a machine-readable code embeddable into the source code of a remote webpage, the machine-readable code specifying a link to video player software and a link to at least one digital video file; and
a second function establishing at least one bidirectional communication session between a remote appliance connected to the webpage and a host server.

2. The system of claim 1, wherein the remote webpage is a personalized blogging webpage or a personalized social interaction webpage.

3. The system of claim 2, wherein the request is initiated by a blogger through the personalized blogging webpage, or by a social interaction site member through the personalized social interaction webpage.

4. The system of claim 1, wherein the host server is the Internet-connected server or a content server connected to the Internet-connected server.

5. The system of claim 1, wherein the at least one bidirectional communication session is brokered by a browser plug-in downloaded to the browser running on the remote appliance during load time of or during play time of the video.

6. The system of claim 1, wherein the remote appliance is one of a desktop computer, a laptop computer, an android device, an iPad, or a smart phone.

7. The system of claim 1, wherein the machine-readable code is redistributed after initial incorporation onto the remote webpage by a visitor to the remote webpage, the redistributed code specifying a different personalized webpage as a new or next destination for installation thereof.

8. The system of claim 1, wherein the one or more digital video files are interactive shopping videos.

9. The system of claim 1, wherein the at least one bidirectional communication event is triggered by a shopper interacting with an interactive component integrated into the one or more digital video files.

10. The system of claim 9, wherein the interactive component is visually displayed within the digital video or video player window during execution of or run time of the digital video.

11. The system of claim 9, wherein the interactive component is one of an interactive video player control or an interactive video overlay.

12. The system of claim 11, wherein the interactive video overlay is one of a logo, an icon, a button, a panel, or an input form.

13. A method for presenting an interactive shopping opportunity to one or more remote shoppers connected to the Internet comprising the steps:
(a) sending a request to a website to serve an embeddable, machine-readable code into a remote webpage, the machine-readable code specifying a link to video player software and a link to at least one digital video file;
(b) at the remote webpage, incorporating the machine-readable code into the source code of the remote webpage; and
(c) executing the code to display the one or more digital video files for execution.

14. The method of claim 13, wherein the remote shoppers are connected to the Internet using one of a desktop computer, a laptop, an android device, an iPad, or a smart phone.

15. The method of claim 13, wherein in step (a), the remote webpage is a personalized blogging webpage or a personalized social interaction webpage.

16. The method of claim 15, wherein in step (a), the request is initiated by a blogger through the personalized blogging webpage, or by a social interaction site member through the personalized social interaction webpage.

17. The method of claim 13, wherein in step (a), the at least one digital video file is an interactive shopping video.

18. The method of claim 13, wherein in step (c), the at least one digital video file is graphically represented in display by one or more video thumbnails.

19. The method of claim 13, wherein in step (c), the at least one digital video file is textually represented in display by one or more hypertexts.

20. The method of claim 13, wherein in step (a), the request is sent as a result of a user clicking on an advertisement.
